(19) United States
(12) Patent Application Publication
(10) Pub. No.: US 2024/0046373 A1
(43) Pub. Date: Feb. 8, 2024

(54) SYSTEM FOR FINDING JOB POSTS OFFERED BY MEMBER'S CONNECTIONS IN REAL TIME

(71) Applicant: Microsoft Technology Licensing, LLC, Redmond, WA (US)

(72) Inventors: Soyeon KI, San Francisco, CA (US); Juan Andres Colmenares Diaz, Santa Clara, CA (US); Kenneth Y. Li, Sunnyvale, CA (US); Asim Anis, Mountain View, CA (US); Huanyu Zhao, Fremont, CA (US); Harsh Vardhan, San Jose, CA (US); Wenqiong Liu, San Francisco, CA (US); Dana M. Tom, Palo Alto, CA (US)

(21) Appl. No.: 17/881,112

(22) Filed: Aug. 4, 2022

(51) Int. Cl. G06Q 50/00

(52) U.S. Cl. CPC G06Q 50/01

(57) ABSTRACT

Methods, systems, and computer programs are presented for finding job-posts shared or posted by connections of a job-seeking member. One method includes an operation for uploading social graph information, resource information, and member information to a data store. The method further includes receiving, by the data store, a request for resources associated with connections of a member, the request comprising a member identifier (ID) of the member. The data store determines first-degree connections of the member ID, and second-degree connections based on the first-degree connections. Further, the data store determines resources associated with any member from the first-degree connections or from the second-degree connections. The method further includes sorting the determined resources based on a relevance of each resource to a profile of the member ID, and causing presentation on a display of at least one of the sorted plurality of resources.

### CROSS-REFERENCE TO RELATED APPLICATIONS

This application is related by subject matter to U.S. Patent Application No. ______ (Attorney Docket No. 3080.O36US1) filed on the same day as the instant application and entitled “Search System and Method to Identify Resources for Connections of a Member in an Online Service”, all of which are incorporated herein by reference in their entirety.

### TECHNICAL FIELD

The subject matter disclosed herein generally relates to methods, systems, and machine-readable storage media for presenting resources available to users in an online service.

### BACKGROUND

Oftentimes, job seekers do not hear back from companies when applying to jobs. It is widely known that a personal introduction to the hiring team improves considerably the chances of getting hired: a LinkedIn internal survey shows that around 50% of the job seekers reach out to people who might be hiring (e.g., the seekers' first-degree connections), or people who might know someone who is hiring (e.g., the seekers' second-degree connections) during job seeking to get help from their network. However, many job seekers mention that their primary challenge to leverage their network when finding a job is that it is difficult to find out who is hiring, or know someone who is hiring, in their network. This is why many job seekers want referrals from their network of connections. However, many job seekers can be frustrated because it is difficult to find out who is hiring in their network.

In an online service with more than eight hundred million members, the number of connections for a member, just considering first- and second-degree connections, can reach a million members or more. Exploring the job posts offered by a million connections for eight hundred million members, and being able to show job posts in real time (e.g., within a few seconds from receiving a request) is a complex problem that requires large amounts computing resources.

### BRIEF DESCRIPTION OF THE DRAWINGS

Various of the appended drawings merely illustrate example embodiments of the present disclosure and cannot be considered as limiting its scope.

FIG. 1 is a screenshot of a member feed, according to some example embodiments.

FIG. 2 is a user interface (UI) for presenting notifications, according to some example embodiments.

FIG. 3 is a UI for presenting job posts, according to some example embodiments.

FIG. 4 is a UI for presenting details of the job post, according to some example embodiments.

FIG. 5 illustrates the flow of operations for finding job posts in the job-seeking member's network, according to some example embodiments.

FIG. 6 illustrates the capturing of data from multiple databases into a single graph database for fast job-post search in a member's network, according to some example embodiments.

FIG. 7 illustrates the traversal of member's connections, according to some example embodiments.

FIG. 8 is a flowchart of a method for finding job posts in the job-seeking member's network, according to some example embodiments.

FIG. 9 is a block diagram illustrating a networked system, according to some example embodiments, including a social networking server, illustrating an example embodiment of a high-level client-server-based network architecture.

FIG. 10 illustrates the training and use of a machine-learning model, according to some example embodiments.

FIG. 11 is a flowchart of a method for finding job-posts shared or posted by the connections of a job-seeking member, according to some example embodiments.

FIG. 12 is a block diagram illustrating an example of a machine upon or by which one or more example process embodiments described herein may be implemented or controlled.

### DETAILED DESCRIPTION

Example methods, systems, and computer programs are directed to finding job-posts shared or posted by the connections of a job-seeking member. As used herein, the term “member” refers to any user that accesses an online service, even though some users may have not gone through the registration process with the online service. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A graph is a collection of points and lines connecting some of the points. The points of a graph are also known as vertices or nodes, and the lines are also known as edges or arcs. Graphs are useful to model many real-life scenarios, like people's connections on a social network, tracking infections on a pandemic, finding resources on a network, finding the best route using public transportation, etc.

Typically, a graph can be stored on a computing system by storing in a database the nodes of the graph and all the edges connecting the nodes. To obtain information from the graph, the computing device traverses the vertices and nodes to get to a particular answer. For example, to find some information for a node on the graph (e.g., connections of a person living within 100 Km), the computing device has to explore all the edges of the node, and then explore the connections of the connections, and so forth, depending on how “deep” the search for the answer goes.

In large graphs, recursively exploring the graph can become very expensive in terms of the amount of computing resources that are needed. There is a popular theory of the seven degrees of separation, where any two people in the world are separated by at most seven connections connecting one person (acquaintance, friend, relative, or other) to another. Thus, going to a recursive search of seven would potentially find all people in a social network that may cover billions of people.

But even just exploring first- and second-degree connections can be an expensive problem in terms of the amount of computing resources that are needed. For example, the online network LinkedIn® has more than 800 million members, and a member may have more than a million connections between first- and second-degree connections. In another example, searching for resources on a network may also require exploring millions or billions of nodes since it is estimated that the Internet includes about 12 billion connected devices.

Typically, the graph is stored in a database and information about the nodes is stored in another database. For example, a graph may include the nodes connected on a network, and a second database includes information for each of the nodes, such as hardware and software installed, available peripherals, available gateway connections, etc. A search for an item associated with a node will require traversing the graph and then making a call for each node to the second database to obtain the information for the node. The traversal of the graph may be expensive (in terms of computing resources) given the exponential growth of nodes as the search goes deeper into deeper connections. If the traversal requires analyzing data for a million nodes or more, this means a million calls to the second database.

Typically, when trying to provide answers in online systems (e.g., providing an answer in 500 ms or less), the aforementioned approach would not work most of the times given the expensive cost, in terms of computing resources, to traverse the graph and all the separate database access calls required to obtain the data for the nodes. The Modern data processing systems can be classified as online, nearline, and offline. Online systems, e.g., for processing business transactions, are handled by front-end relational databases and serve results within milliseconds. Nearline systems typically operate in the order of seconds, and offline systems within minutes or hours. As companies realize the increased business and value of analyzing data with low latency, the trend is towards an increased number of resources for nearline back-end systems. Both nearline and offline systems typically ingest data from other servers and databases. As used herein, responding in real time or near real time refers to online systems that can respond within a time period in the range from a few milliseconds to a few seconds after receiving a request, such as response times in the range from 50 milliseconds to five seconds. Despite accessing large amounts of data, the solutions described herein achieve high-throughput and low-latency data reads.

In one aspect, a solution for extracting graph information creates a database that stores the connection information for each node of the graph, that is, a list of all the first-degree connections for each node of the graph. Also, for each connection, information about the connection node is stored so when a query is received, all the information is available in the database to be able to quickly find the connections and resources that meet the query criteria without having to access other databases. Once the required items are found (e.g., social connections living in the same city), some additional information may be obtained but from a much smaller set of data (e.g., hundreds of items instead of millions) or additional filtering applied on the much smaller set of data. This new database that is created and the resultant searching method provides a new specific technical implementation that reduces the computing resources used to perform searches and the time taken to perform those searches. The implementation described herein is independent of the nature of the information that is represented by the graph and references to job posts in the following description is by way of example.

A query is received, with an identifier of a source node, to find resources (e.g., job posts) associated with connections of the source node. The system searches for nodes connected to the source node in the request (e.g., first- and second-degree connections) to find the resources associated with these connections. The response to the query includes one or more of the resources offered by the connections of the source node.

Embodiments of the invention are described with reference to a social graph that is a social network system, and the resource searched is job posts of interest to members of the social network system. However, the same principles may be applied to other solutions, such as finding people that have been in contact with a person in the last week and that have been in locations where infected people have been found. Another solution may include finding people that went to the same high school of a member thirty years ago and that are living in Europe. Another solution may include finding friends that would like to see a restaurant review created by a member. Another solution may be finding people in a dating site that live in the same city and like to play chess. As noted above, the techniques described herein can be applied to improve the ability to search a graph that represents any type of data.

One feature of the LinkedIn® online service is that members can share job posts to the community (e.g., using the feature called #Hiring) to let others know that the sharing member's company, and more specifically the sharing member's team, is hiring for a particular job. The job sharer may be different than the job poster, e.g., a recruiter for the same company. A job-seeking member can benefit by knowing who is hiring from his first- and second-degree connections. However, given the large number of members in the online service, it is difficult to quickly identify when a job-seeking member's connection is hiring. Further, a company of a connection may be hiring, but the connection may be completely unrelated to that job post.

In one aspect, notifications are generated in real-time for resources available to members when a connection of the member has indicated that the connection is associated with the resource (e.g., the resource is available through the connection). With reference to job posts, notifications are generated in real-time for job-seeking members when a connection of the job-seeking member has indicated that the connection is hiring (e.g., job sharing or job posting) for a job of interest to the job-seeking member. A notification is sent to the job-seeking member notifying that her connection can be leveraged to get the job that matches the professional interest of the job-seeking member.

In another aspect, a database is designed to store connection information and job-post information in order to quickly retrieve job posts posted or shared by the network of a job-seeking member. The job posts for the job-seeking member are identified by searching the database of network connections and job posts, and the job posts are prioritized based on the relevance to the job-seeking member and the availability of a direct connection (e.g., first or second degree) that has indicated to be hiring for the job post.

Further, when job posts are presented to the job-seeking member, an indication is presented in the job post when a direct connection of the job-seeking member is hiring for that job post, giving the job-seeking member an incentive to apply for that job because the job-seeking member can leverage the connection to be used as a referral.

For the purposes of this description the phrases “an online social networking application” and “an online social network system” may be referred to as and used interchangeably with the phrases “an online system,” “an online service,” “a networked system,” or merely “a connections network.” It will also be noted that a connections network may be any type of an online network, such as, e.g., a professional network, an interest-based network, or any online networking system that permits users to join as registered members. For the purposes of this description, registered members of a connections network may be referred to as simply members. Further, some connections networks provide services to their members (e.g., search for jobs, search for candidates for jobs, job posts) without being a social network, and the principles presented herein may also be applied to these connection networks.

A graph database is a data repository that stores nodes and relationships instead of tables, or documents. In the graph database, entities (e.g., members, organization, and job posts) are vertices and the relations between them are the edges of the graph (e.g., member M₁ is connected to member M₂, member M₁ works at company C₁, and member M₁ published a job post JP₄). The first-degree connections of a member, also referred to as one-hop connections in the graph, are other members directly connected with the member. Further, the second-degree connections of a member are the direct connections of the member's direct connections (i.e., friends of friends).

One general aspect includes a method that includes an operation for uploading social graph information, resource information, and member information to a data store. The method further includes receiving, by the data store, a request for resources associated with connections of a member, the request comprising a member identifier (ID) of the member. The data store determines a plurality of first-degree connections of the member ID, and a plurality of second-degree connections based on the plurality of first-degree connections. Further, the data store determines a plurality of resources associated with any member from the plurality of first-degree connections or from the plurality of second-degree connections. The method further includes sorting the determined plurality of resources based on a relevance of each resource to a profile of the member ID, and causing presentation on a display of at least one of the sorted plurality of resources.

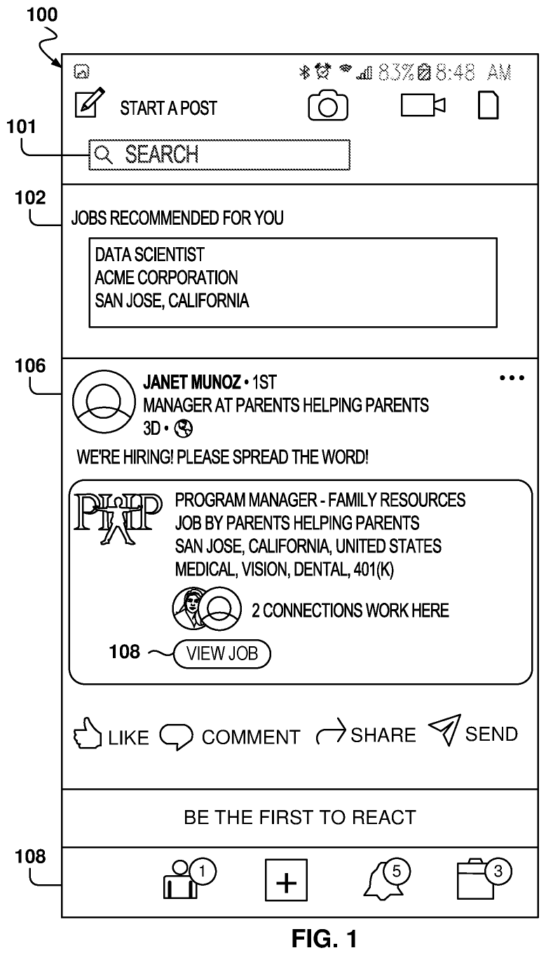

FIG. 1 is a screenshot of a member feed 100, according to some example embodiments. The member feed 100 may include items in different categories, such as search field 101, job recommendations 102, job post 106, sponsored items, shortcuts 108, news, messages, articles, and other information items.

In one example embodiment, a social network service user interface provides the job recommendations 102 that match the job interests of the job-seeking member and that are presented without a specific job search request from the job-seeking member, referred to herein as “jobs you may be interested in” (JYMBII). In other example embodiments, the member feed 100 includes suggestions or recommendations (not shown) for adding new connections, a feature referred to herein as People You May Know (PYMK).

The job post 106 includes information about a job post that has been shared or posted by a connection of the job-seeking member. A posting member or a sharing member using the #Hiring feature indicates that the member, or the company of the member, is hiring on the online service to attract qualified candidates taking advantage of the member's network. The sharing member can share that the sharing member is #Hiring in multiple ways, such as adding to the sharing member's profile, adding on the homepage of the sharing member, creating a job post with the #Hiring tag, using the #Hiring photo frame on the profile photo, and sending messages to other members. The sharing member may also invite coworkers to share the job and add the #Hiring photo frame to their profile photo.

The job post 106 provides information on the company hiring and the posting member (e.g., her current position and employer, and her distance to the viewing member on the social network). The viewing member may select the job post and then find more information about the job post.

Other member posts may include items posted by members of the social network service (e.g., items posted by connections of the member), and may be videos, comments made on the social network, pointers to interesting articles or webpages, among other information items.

Additionally, the member may receive in-network communications from other members. The communications may originate by other members who are socially connected with the member or by unconnected members.

In some example embodiments, shortcuts 108 are provided in the feed 100, such as links for accessing the homepage, accessing members in my network, and adding a post, notifications, and jobs. As used herein, a notification is a message sent to the member. The notification may be sent in multiple ways, such as a message within an application executing on a computing device, a notification sent to a device (e.g., notification presented on a mobile phone), an email, a text message, a WhatsApp message, or a message on a social network sent to the member.

The icons in the shortcuts 108 area include notification counters presented within a circle next to the icon. In the illustrated example, there is one message from the member's network, six app notifications, and three job suggestions.

An example of a notification is a message indicating that a network connection is hiring for a job that matches the job-seeking member's skills and requirements for a new job. Another example of a notification is a message regarding people you may know (PYMK) suggesting a new connection on the online service. Another type of notification is a new job that may be interesting for the job-seeking member.

In general, job seeker members want to use their network to find new jobs because having an inside connection greatly improves the chances of landing the new job. As used herein, embodiments refer to the network of a member as first- and second-degree connections, but the principles presented may also be applied to just first-degree connections, or first to third degree, first to fourth degree, etc.

Job-seeking members find it challenging to find jobs offered by their connections given the large number of jobs in the online service. Also, a large company (e.g., Microsoft), may be offering hundreds of jobs. Although the job-seeking member may have a connection at Microsoft, this does not mean that the connection is related to a particular job post (e.g., the job may be in another division or in another country).

Additionally, it has been observed that even members that are not active job seekers are interested in being notified about jobs in their first-degree network, and the primary reason is the belief that “I may casually find a job opportunity that interests me.”

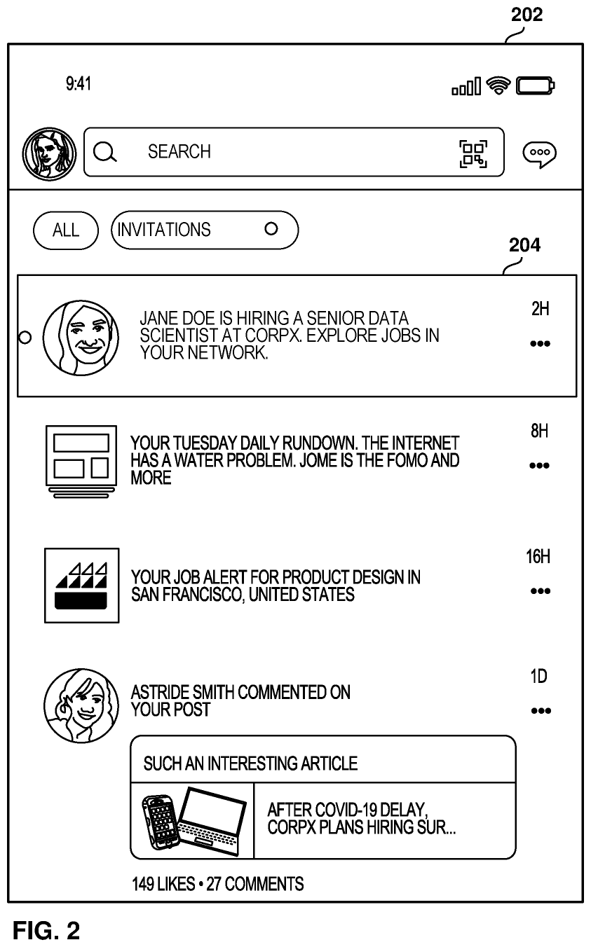

FIG. 2 is a user interface (UI) 202 for presenting notifications, according to some example embodiments. A recruiter posting a new job (using #Hiring frame) is able to reach potential job candidates. Also, a sharing member may share a job post using #Hiring to indicate that his company is hiring in a job associated with the sharing member, such as the group or organization of the sharing member inside the company. In some example embodiments, a job-seeking-intent score (JSIC) is used to limit notifications to job seekers that are actively looking for a new job, but other embodiments may also send to people not actively looking, e.g., the job is a good match for the member's skills and has been shared by a first-degree connection.

The JSIC indicates how active the job-seeking member is in seeking for a new job, and the higher the JSIC, the more active the job-seeking member is in the search for the new job. The JSIC is based on the job-seeking member's activities regarding job searches, job-title match, and the open-to-work feature enabled in the job-seeking member's profile. Notifications are then sent if the JSIC is above a predetermined threshold. Different notifications may be sent depending on the degree and strength of a connection and the relevance of the job post to the job-seeking member. As soon as the job poster adds or shares a job post to their profile, the network connections will receive the job notification in near real time.

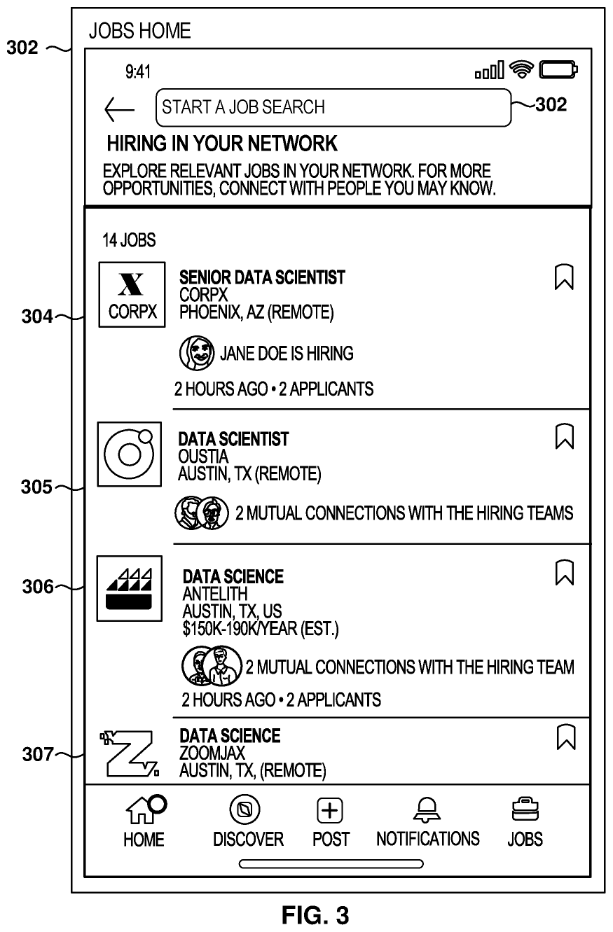

The UI 202 includes a list of notifications 204. For example, a connection named Jane Doe is hiring a Senior Data Scientist at CorpX, and the connection is part of the job-seeking member's network. Once the job-seeking member clicks into the notification 204, a list of relevant job posts is presented, such as the example described below with reference to FIG. 3.

FIG. 3 is a UI 302 for presenting a list of job posts, according to some example embodiments. When the job-seeking member accesses the jobs UI 302, the online service selects the relevant job posts 304, 305, 306, and 307 for the job-seeking member based on several factors, such as the relevance of the job post to the member's profile, a score of the connection strength between the job-seeking member and sharing or posting member, as well as the job location, the title of the open position, and the skills required.

The UI 302 presents the list of job posts 304-307 based on their relevance to the viewing member. For example, job post 304 corresponds to the notification 204 sent to the viewing member, as shown in FIG. 2. The job posts that are offered by the viewing member's network also shows the connection of the viewing member associated with the job post. For example, the job post 304 shows that a connection of the viewing member, Jane Doe, is hiring.

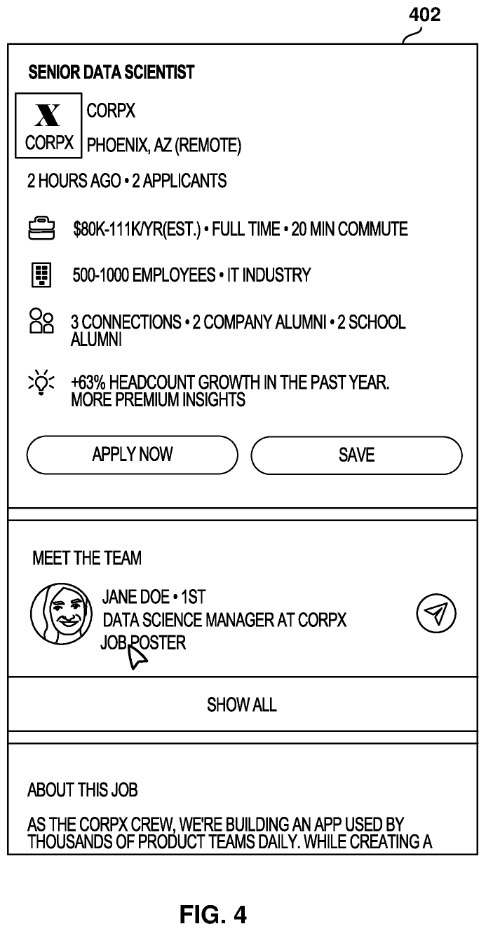

FIG. 4 is a UI 402 for presenting details of the job post, according to some example embodiments. When the job-seeking member clicks on the job post 304 of the UI 302, the details of the job post are presented in UI 402.

The job details include information about the location, the expected salary, the company, number of connections in the company, and the connections that are sharing the job post, such as Jane Doe in this example, who is a first-degree connection of the job-seeking member. Further, a job description is included. If the job-seeking member had more connections sharing the job post 304, the additional connections would also be presented.

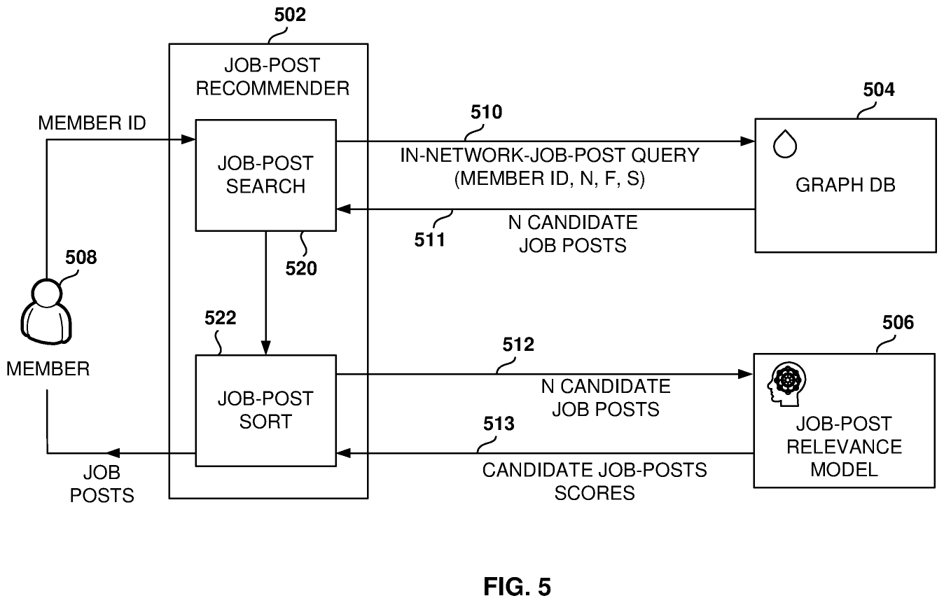

FIG. 5 illustrates the flow of operations for finding job posts in the job-seeking member's network, according to some example embodiments. A job-seeking member 508 sends a query to the job-post recommender 502 for job posts posted or shared by the network connections of the job-seeking member 508. The request is associated with the member ID of the job-seeking member. As used herein, a job posted or shared by a member is referred to as a job sponsored by the member; that is, the member has posted the job post or the member has shared the job post using the #Hiring feature. Further, a sponsoring member refers to a sharing member or a posting member.

Although some embodiments are presented with reference to finding job posts in response to a request by the job-seeking member, the same principles may also be utilized for other search scenarios, such as searches initiated by the online service for job posts that may be of interest to a member. Whilst the following description refers to job posts, these are one example of a resource that may be offered (or sponsored) by or otherwise associated with a member.

The job-post recommender 502 interacts with an online graph database 504 to obtain candidate job posts shared or posted by connections of the job-seeking member 508. Further, the job-post recommender 502 utilizes a job-post relevance model 506 to select the job posts that are more relevant for the job-seeking member 508.

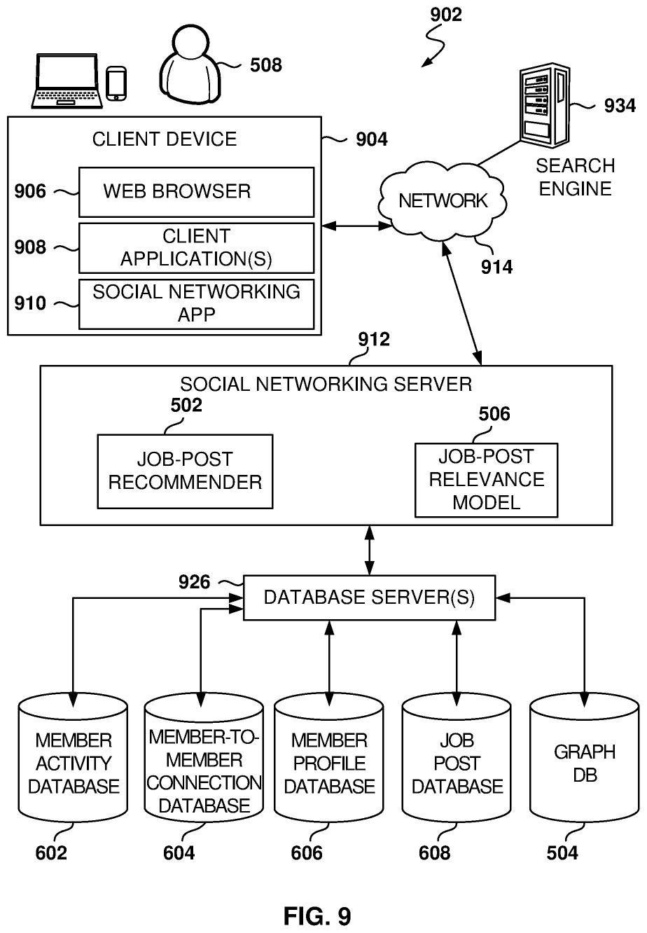

The online service reads information from one or more databases and then stores this information in the graph DB 504, and the graph DB 504 is able to find candidate job posts without having to search other databases, such as the job-post database 608 illustrated in FIG. 9. By caching this data in advance, the online service is able to provide online responses in real time to the query for job posts. That is, there is no need to access the member profile database or the job-posts database in order to determine if the job-post is a match for the member.

For the general framework of the technical solution, the graph is the online service social graph with vertices being the members of the online service and the edges being the existing connections in the online service. Further, the resource is the job post that is analyzed to determine if the job post is sponsored by one of the connections of the member.

The online graph database 504 answers graph queries with low latency (e.g., tens of milliseconds) to support real-time applications. For example, LIquid is a proprietary online graph database built at and operated by LinkedIna LIquid operates with data only in memory, scales horizontally, and is highly available.

An online graph database 504, like LIquid, is a specialized, single-purpose platform for creating and manipulating graphs. Graphs contain nodes, edges, and properties, all of which are used to represent and store data in a way that relational databases are not equipped to do. The online graph database 504 stores the social graph defined by the members' connections in the online service. LIquid stores nodes that represent job posts and edges that link the posts with the sponsoring (posting or sharing) members.

Typically, the value of connections to an average member resides in leveraging the first- and second-degree connections. The second-degree connections are the connections of the first-degree connections, such as the colleague of an old school friend, or the new boss of a co-worker from a prior job.

In some example embodiments, the online graph database 504 provides responses to a InNetworkJobPost query 510 (a candidate-selection query) that powers online job-post recommendations that fall under the #Hiring feature. The InNetworkJobPost query's objective is to return candidate job posts, that the job-seeking member 508 might be interested in, by traversing the job-seeking member's first- and second-degree connections in the social graph. Given the member ID, the job-post recommender 502 retrieves job posts that have been posted or shared by the job-seeking member's first- and second-degree connections. The process may be repeated to obtain the second-degree connections. In other examples, the third-degree connections may be obtained from the second-degree connections. In other examples, the fourth-degree connections may be obtained from the third-degree connections.

In some example embodiments, the candidate-selection queries filter first- and second-degree members that have been inactive for a predefined period of time (e.g., three months, six months, but other time periods are also possible).

The job-post recommender 502 includes a job-post search module 520 and a job-post sort module 522. The job-post search module 520 interacts with the online graph database 504 to obtain candidate job posts, and the job-post sort module 522 uses a job-post relevance model 506 to sort the candidate job posts based on the relevance to the job-seeking member 508.

In some example embodiments, the job-post search module 520 sends the InNetworkJobPost query 510 to the online graph database 504 to request the job posts for the member ID associated with the #Hiring feature. The InNetworkJobPost query includes the member ID.

In some example embodiments, the InNetworkJobPost query 510 also includes a number N that is the maximum number of job posts to be returned in response.

In some example embodiments, the InNetworkJobPost query 510 includes a number F that is the maximum number of first-degree connections to be searched for job connections.

In some example embodiments, the InNetworkJobPost query 510 includes a number S that is the maximum number of second-degree connections to be searched for a first-degree connection. Since second-degree connections may be in the order of a million, limiting the number of first- and second-degree connections allows the online graph database 504 to speed up responses to meet the requirements on result counts and latency.

Except for the member ID, the parameters for the InNetworkJobPost query 510 are optional. By supporting these parameters, the online graph database 504 gives the requester more control on how many connections and job posts to explore in order to satisfy their needs for response time and relevance. The goal is to find the most relevant job posts even when including the parameters to limit the search.

In some example embodiments, the online graph database 504 has a requirement to respond to the InNetworkJobPost query 510 within a predetermined amount of time, such as 100 ms, but other embodiments may have more laxed response time requirements (e.g., 500 ms or more).

In some example embodiments, the online graph database 504 sorts the first-degree connections according to a connection score (CS) between the job-seeking member and the connection, and then the top F first-degree connections are selected before continuing the graph traversal across the connected-to relations and searching for second-degree connections via the selected first-degree connections. The CS is a number that indicates how closely connected two members are, and the higher the CS, the more interactions are taking place between the two members in the online service.

In some example embodiments, the online graph database 504 stores the CS along with each connection. Further, the online graph database 504 sorts the first-degree connections according to their CS.

Further, the second-degree connections may be sorted according to their connection score and then the top S second-degree connections are selected for searching job posts shared or posted by the selected second-degree connections.

At operation 511, the online graph database returns N candidate job posts to the job-post search module 520 in response to the InNetworkkbPost query 510. Afterwards, the job-post sort module 522, obtains, for each returned candidate job-post, a job-post relevance score using the job-post relevance model 506. The job-post sort module 522 requests 512 the job-post relevance score and the job-post relevance model 506 returns 513 the job-post relevance score. The job-post relevance score is a number that indicates how relevant a job-post is to a job-seeking member, and the higher the number, the more relevant the job-post is for the member.

With the job-post relevance scores, the job-post sort module 522 sorts the candidate job posts according to their job-post relevance scores. Once the job-posts are sorted, a plurality of the top job posts is returned and at least one job post is presented to the job-seeking member 508.

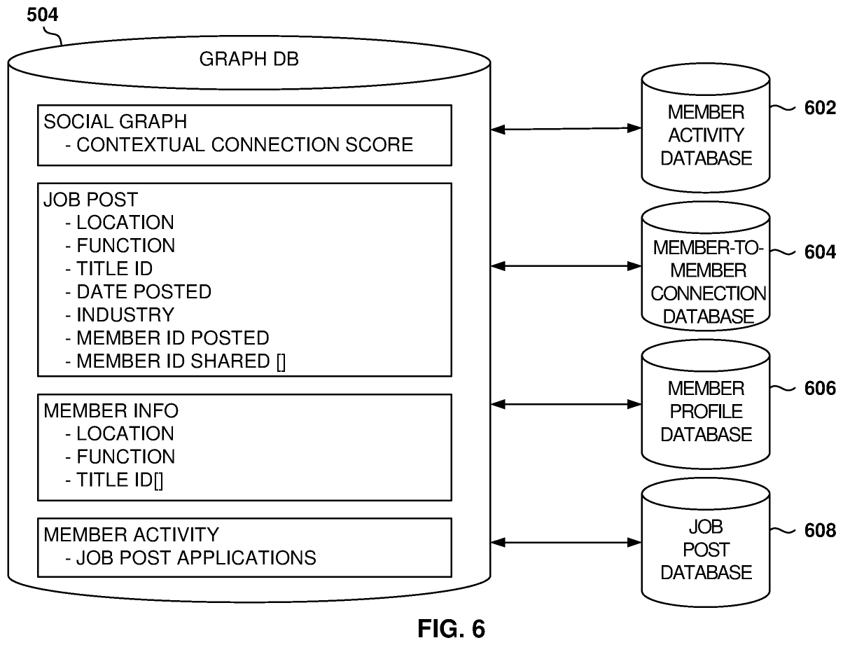

FIG. 6 illustrates the capturing of data from multiple databases into a single online graph database 504 for fast job-post search in a job-seeking member's network, according to some example embodiments. To be able to provide online support for finding #Hiring job posts, the online graph database 504 gets data from other databases that store this data.

The activities of members while interacting with the online service are stored in the member activity database (DB) 602. Examples of interactions include, but are not limited to, commenting on posts entered by other members, viewing member profiles, editing or viewing a member's own profile, sharing content outside of the social networking service (e.g., an article provided by an entity other than the social networking server), updating a current status, posting content for other members to view and comment on, posting job suggestions for the members, searching job posts, and other such interactions. In one embodiment, records of these interactions are stored in the member activity DB 602, which associates interactions made by a member with his or her member profile stored in the member profile database 606.

The member-to-member connection DB 604 contains the connections between members in the online service; that is, for each member, a list with the connections of the member is stored in the member-to-member connection DB 604.

The member profile database 606 stores the profile information of members who have registered with the online service. With regard to the member profile database 606, the member may be an individual person or an organization, such as a company, a corporation, a nonprofit organization, an educational institution, or other such organizations.

The job post DB 608 includes job posts offered by employers. Each job post includes job-related information such as any combination of employer, job title, job description, requirements for the job post, salary and benefits, geographic location, one or more job skills desired, day the job post was posted, relocation benefits, and the like.

In some example embodiments, the online graph database 504 collects the social graph information from the member-to-member connection DB 604, including the existing connections in the online service and the CS for each connection.

Further, the online graph database 504 collects job-post information from the job post DB 608. The job-post information includes, for each job post, the location, the functional area, one or more title IDs, date the job post was posted, industry ID (industry associated with the job post), member ID of the posting member that posted the job post, and zero or more member IDs of sharing members that shared the job post via the #Hiring function.

Furthermore, the online graph database 504 collects member information, from the member profile DB 606, including location, functional area, and one or more title IDs.

In some example embodiments, the online graph database 504 collects member activity information, from the member activity DB 602, including the job posts where the member submitted applications.

Once the online graph database 504 collects this information, the online graph database 504 is able to execute the InNetworkJobPost query and find the job posts posted or shared by member connections using the information in the graph DB 504. The information collected allows the graph DB 504 to respond to queries for job posts in real time, without having to retrieve data from other databases. More generally where the resource is not a job-post, this collected information is used to find resources associated with network connections without requiring access to other databases. Thus, the graph DB 504 can fetch first- and second-degree connections of a member in near real time because the data has already been organized and cached.

It is noted that the embodiments illustrated in FIG. 6 are examples and do not describe every possible embodiment. Other embodiments may store additional or fewer data in the online graph database 504. The embodiments illustrated in FIG. 6 should therefore not be interpreted to be exclusive or limiting, but rather illustrative.

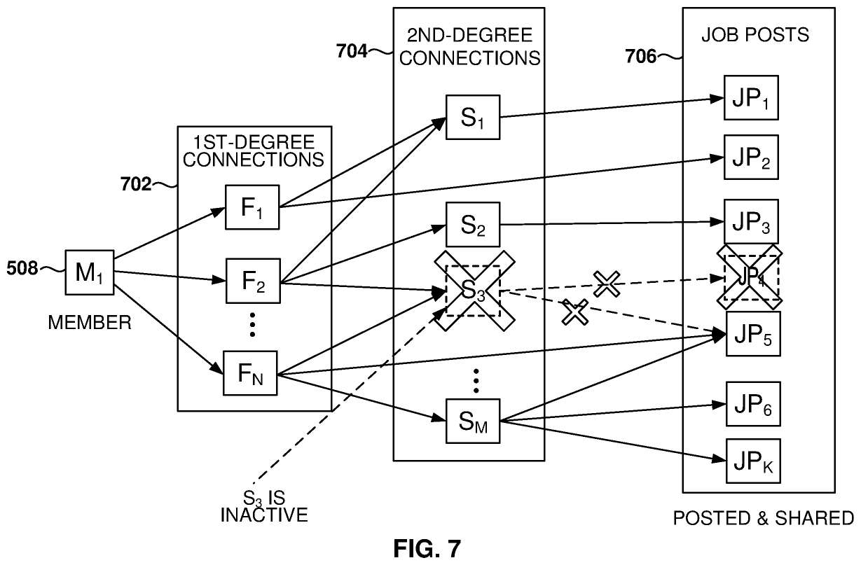

FIG. 7 illustrates the traversal of member's connections, according to some example embodiments. With a limit of 30,000 first-degree connections per member, the maximum number of second-degree connections a member can have is 900 million (30 K×30 K). Moreover, there can be millions of active job posts at any given time. In short, there is large liquidity of connections and job posts in the online service.

A complete implementation of the InNetworkJobPost query to consider all the connections and all the job posts would require an extremely large number of computing resources and the response time could degrade into the order of minutes or more. For example, the InNetworkJobPost query could consider two million connections and examine a million job posts that would exceed the desired latency time limit for the response.

One goal is to produce relevant job posts while meeting the result count and response-latency requirements. By limiting the number of first-degree connections, second-degree connections, and job posts searched, the online graph database can provide high-quality results in near real time. To provide high-quality results, the online graph database sorts the first- and second-degree connections according to their CS, guaranteeing that the job-seeking member's network selected are the best connections for the job-seeking member because they are the strongest connections sharing or posting jobs.

As discussed above, the InNetworkJobPost query may include arguments for the Member ID, N, F, and S. In some embodiments, S is not used, and a single parameter F is provided for the maximum number of first- and second-degree connections.

Once the online graph database receives the InNetworkJobPost query, the online graph database finds the first-degree connections 702 (Fr to FN) for the member ID Mt and selects the top F connections according to their connection-strength scores. Additionally, inactive connections are filtered out from the first-degree connections.

It is noted that other filtering criteria are possible based on properties of the connections and the members. For example, another type of filtering can restrict the search to connections in the same country as the job-seeking member. Further, another type of filtering may restrict the connections to connections that work in the same industry as the job-seeking member.

Afterwards, from the selected first-degree connections, the top S second-degree connections 704 are selected based on their CCX scores after filtering out the inactive connections.

After the F first-degree connections 702 and the S second-degree connections 704 are determined, the online graph database finds the job posts 706 (JP₁-JP_{K} except JP₄) posted or shared by F and S. The job posts from inactive connections are not selected, unless they are also selected through active first- or second-degree connections.

In some example environments, from the identified job posts 706, the online graph database selects a subset of N job posts 706. One criterion is to select the N most recent job posts based on their posting times. Alternatively, the selection could be done based on job-post ID in descending order. The selected Njob posts are then returned in response to the InNetworkJobPost query.

In the illustrated example S₃ is an inactive member that is a second-degree connection of member M1. Since S₃ is inactive, S₃ is eliminated from consideration. Consequently, job post JP₄ posted or shared by S₃ is also eliminated. It is noted that JP₅ is also shared or posted by S₃, but JP₅ is not eliminated because JP₅ has been shared or posted by first-degree connection F₁.

Selecting job posts based on their recency is one of the possible criteria. Other criteria for selecting job posts include: location (e.g., filtering by country, state, or cosmopolitan area); job relevance based on the relevance of the job post to the job-seeking member (e.g., functional area or skills required); job title to select job posts that match the title of the job-seeking member; job freshness defined by date job was posted (e.g., filtering job posts that are more than 30-days old); connection degree (e.g., to prioritize job posts from first-degree over those from second-degree connections); or prioritize connections posting over connections sharing the job posts, or vice versa.

Two or more selection criteria may be combined in different embodiments, such as location, job relevance, and job freshness, but other combinations are also possible.

It is noted that embodiments are presented for selecting job posts that have been shared or posted by the network connections, but other embodiments may utilize the same principles for finding any type of job post associated with one of the job-seeking member's connections (e.g., at the same company).

In some example embodiments, the job posts for the company where the job-seeking member works are also filtered out to avoid presenting job posts of the current company.

Additionally, in some embodiments, if there is a block between the job-seeking member and a connection (the job-seeking member has blocked the connection or the connection has blocked the job-seeking member), the connection is filtered out as well as the job posts shared or sponsored by the blocked connection.

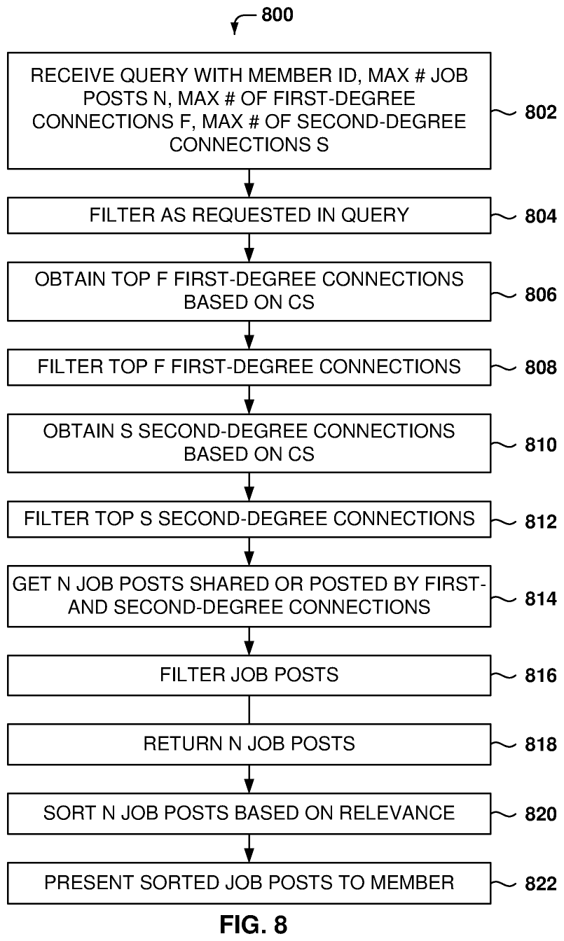

FIG. 8 is a flowchart of a method 800 for finding job posts in the job-seeking member's network, according to some example embodiments. While the various operations in this flowchart are presented and described sequentially, one of ordinary skill will appreciate that some or all of the operations may be executed in a different order, be combined or omitted, or be executed in parallel.

At operation 802, the InNetworkJobPost query is received specifying the member ID and optionally the maximum number N of job posts to be returned, the maximum number F of first-degree connections, or the maximum number S of second-degree connections.

From operation 802, the method 800 flows the operation 804 to perform any preliminary filtering based on filter parameters included in the request.

From operation 804, the method 800 flows to operation 806 to obtain a maximum of F first-degree connections based on the CCX between the job-seeking member associated with the member ID in the InNetworkJobPost query and the connection.

From operation 806, the method 800 flows to operation 808 to filter the obtained top F first-degree connections. For example, inactive first-degree connections are filtered out from further consideration.

From operation 808, the method 800 flows the operation 810 to obtain a maximum of S second-degree connections based on the CCX between the job-seeking member associated with the member ID in the InNetworkJobPost query and the connection.

From operation 810, the method 800 flows to operation 812 to filter the obtained top S second-degree connections. For example, inactive second-degree connections are filtered out from further consideration.

From operation 812, the method 800 flows the operation 814 to get a maximum N of job posts that have been shared or posted by the obtained first- or second-degree connections.

From operation 814, the method 800 flows to operation 816 to filter the obtained N job posts. For example, job posts in a different country or a different industry can be filtered out.

From operation 816, the method 800 flows the operation 818 to return the job posts after the filtering at operation 816.

From operation 818, the method 800 flows the operation 820 to sort the remaining job posts based on the job-post relevance of the job post to the job-seeking member.

From operation 820, the method 800 flows the operation 822 where the sorted job posts are presented on a user interface of the job-seeking member.

FIG. 9 is a block diagram illustrating a networked system, according to some example embodiments, including a social networking server 912, illustrating an example embodiment of a high-level client-server-based network architecture 902. Embodiments are presented with reference to an online service, and, in some example embodiments, the online service is a social networking service.

The social networking server 912, a distributed system comprising one or more machines, provides server-side functionality via a network 914 (e.g., the Internet or a wide area network (WAN)) to one or more client devices 904. FIG. 9 illustrates, for example, a client device 904 with a web browser 906, client application(s) 908, and a social networking app 910 executing on the client device 904. The social networking server 912 is further communicatively coupled with one or more database servers 926 that provide access to one or more databases 602, 604, 606, 608, and 504.

The social networking server 912 includes, among other modules, the job-post recommender 502 in the job-post relevance model 506. The client device 904 may comprise, but is not limited to, a mobile phone, a desktop computer, a laptop, a tablet, a netbook, a multi-processor system, a microprocessor-based or programmable consumer electronic system, or any other communication device that the member 508 may utilize to access the social networking server 912. In some embodiments, the client device 904 may comprise a display module (not shown) to display information (e.g., in the form of user interfaces).

In one embodiment, the social networking server 912 is a network-based appliance, or a distributed system with multiple machines, that responds to initialization requests or search queries from the client device 904. Online data systems, like the online graph database 504, operate as shared services at the bottom of a multi-tier architecture, with microservices in the middle and Application Programming Interface (API) gateways as entry points for external mobile or web client applications. One or more members 508 may be a person, a machine, or other means of interacting with the client device 904. In various embodiments, the member 508 interacts with the network architecture 902 via the client device 904 or another means.

In some embodiments, if the social networking app 910 is present in the client device 904, then the social networking app 910 is configured to locally provide the user interface for the application and to communicate with the social networking server 912, on an as-needed basis, for data and/or processing capabilities not locally available (e.g., to access a member profile, to authenticate a member 508, to identify or locate other connected members 508, etc.). Conversely, if the social networking app 910 is not included in the client device 904, the client device 904 may use the web browser 906 to access the social networking server 912.

In addition to the client device 904, the social networking server 912 communicates with the one or more database servers 926 and databases. In one example embodiment, the social networking server 912 is communicatively coupled to the member activity database 602, the member-to-member connection DB 604, the member profile database 606, the job-post database 608, and the online graph database 504. The databases may be implemented as one or more types of databases including, but not limited to, a hierarchical database, a relational database, a graph database, an object-oriented database, one or more flat files, or combinations thereof.

In some example embodiments, when a member 508 initially registers to become a member 508 of the social networking service provided by the social networking server 912, the member 508 is prompted to provide some personal information, such as name, age (e.g., birth date), gender, interests, contact information, home town, address, spouse's and/or family members' names, educational background (e.g., schools, majors, matriculation and/or graduation dates, etc.), employment history (e.g., companies worked at, periods of employment for the respective jobs, job title), professional industry (also referred to herein simply as “industry”), skills, professional organizations, and so on. This information is stored, for example, in the member profile database 606. Similarly, when a representative of an organization initially registers the organization with the social networking service provided by the social networking server 912, the representative may be prompted to provide certain information about the organization, such as a company industry.

While the database server(s) 926 are illustrated as a single block, one of ordinary skill in the art will recognize that the database server(s) 926 may include one or more such servers. Accordingly, and in one embodiment, the database server(s) 926 implemented by the social networking service are further configured to communicate with the social networking server 912.

The network architecture 902 may also include a search engine 934. Although only one search engine 934 is depicted, the network architecture 902 may include multiple search engines 934. Thus, the social networking server 912 may retrieve search results (and, potentially, other data) from multiple search engines 934. The search engine 934 may be a third-party search engine.

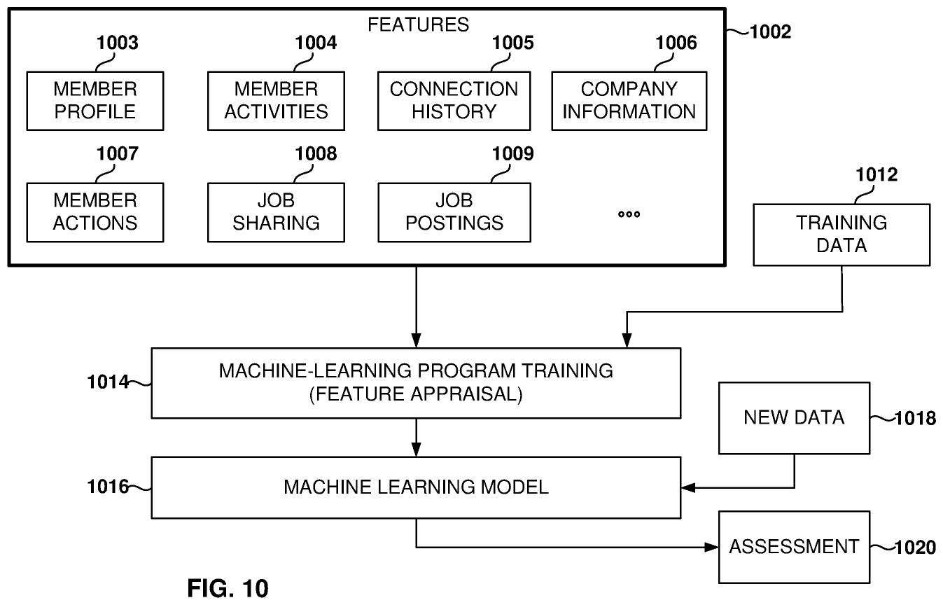

FIG. 10 illustrates the training and use of a machine-learning model, according to some example embodiments. In some example embodiments, machine-learning (ML) models 1016, are utilized to calculate the job-post relevance, the job-seeking-intent score (JSIC), and the CS.

Machine Learning (ML) is an application that provides computer systems the ability to perform tasks, without explicitly being programmed, by making inferences based on patterns found in the analysis of data. Machine learning explores the study and construction of algorithms, also referred to herein as tools, that may learn from existing data and make predictions about new data. Such machine-learning algorithms operate by building an ML model 1016 from example training data 1012 in order to make data-driven predictions or decisions expressed as outputs or assessments 1020. Although example embodiments are presented with respect to a few machine-learning tools, the principles presented herein may be applied to other machine-learning tools.

There are two common modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the ML model can implement the same relationships when given inputs to generate the corresponding outputs. Unsupervised ML is the training of an ML algorithm using information that is neither classified nor labeled, allowing the algorithm to act on that information without guidance. Unsupervised ML is useful in exploratory analysis because it can automatically identify structure in data.

Common tasks for supervised ML are classification problems and regression problems. Classification problems, also referred to as categorization problems, aim at classifying items into one of several category values (for example, is this object an apple or an orange?). Regression algorithms aim at quantifying some items (for example, by providing a score to the value of some input). Some examples of commonly used supervised-ML algorithms are Logistic Regression (LR), Naive-Bayes, Random Forest (RF), neural networks (NN), deep neural networks (DNN), matrix factorization, and Support Vector Machines (SVM).

Some common tasks for unsupervised ML include clustering, representation learning, and density estimation. Some examples of commonly used unsupervised-ML algorithms are K-means clustering, principal component analysis, and autoencoders.

The job-post relevance indicates how relevant is a job post to the job-seeking member. In some example embodiments, the job-post relevance is a number (e.g., in the range of 1 to 100) that indicates the relevance, and the higher the job-post relevance, the more relevant the job-post is to the job-seeking member.

The training data 1012 comprises examples of values for the features 1002. In some example embodiments, the training data comprises labeled data with examples of values for the features 1002 and labels indicating the outcome, such as member applied for the job post, member requested details for the job post, member responded to a notification about the job post, etc. The machine-learning algorithms utilize the training data 1012 to find correlations among identified features 1002 that affect the outcome. A feature 1002 is an individual measurable property of a phenomenon being observed. The concept of a feature is related to that of an explanatory variable used in statistical techniques such as linear regression. Choosing informative, discriminating, and independent features is important for effective operation of ML in pattern recognition, classification, and regression. Features may be of different types, such as, numeric, strings, categorical, and graph. A categorical feature is a feature that may be assigned a value from a plurality of predetermined possible values (e.g., this animal is a dog, a cat, or a bird).

In one example embodiment, the features 1002 may be of different types and may include one or more of member profile information 1003, member activity information 1004 (e.g., articles read, jobs applied to, connections made, articles posted, jobs posted), connection history 1005, company information 1006, member actions 1007, jobs shared or posted 1008, job posts 1009, etc.

During training 1014, the ML program, also referred to as ML algorithm or ML tool, analyzes the training data 1012 based on identified features 1002 and configuration parameters defined for the training. The result of the training 1014 is the ML model 1016 that is capable of taking inputs to produce assessments.

Training an ML algorithm involves analyzing large amounts of data (e.g., from several gigabytes to a terabyte or more) in order to find data correlations. The ML algorithms utilize the training data 1012 to find correlations among the identified features 1002 that affect the outcome or assessment 1020. In some example embodiments, the training data 1012 includes labeled data, which is known data for one or more identified features 1002 and one or more outcomes.

The ML algorithms usually explore many possible functions and parameters before finding what the ML algorithms identify to be the best correlations within the data; therefore, training may make use of large amounts of computing resources and time.

When the ML model 1016 is used to perform an assessment, new data 1018 is provided as an input to the ML model 1016, and the ML model 1016 generates the assessment 1020 as output. For example, the job-post relevance is calculated as the assessment 1020 when the member ID and the job-post ID are used as inputs. In another example, the CC is calculated as the assessment 1020 when the member IDs of the two members in the connection are provided.

In some example embodiments, results obtained by the model 1016 during operation (e.g., assessments 1020 produced by the model in response to inputs) are used to improve the training data 1012, which is then used to generate a newer version of the model. Thus, a feedback loop is formed to use the results obtained by the model to improve the model.

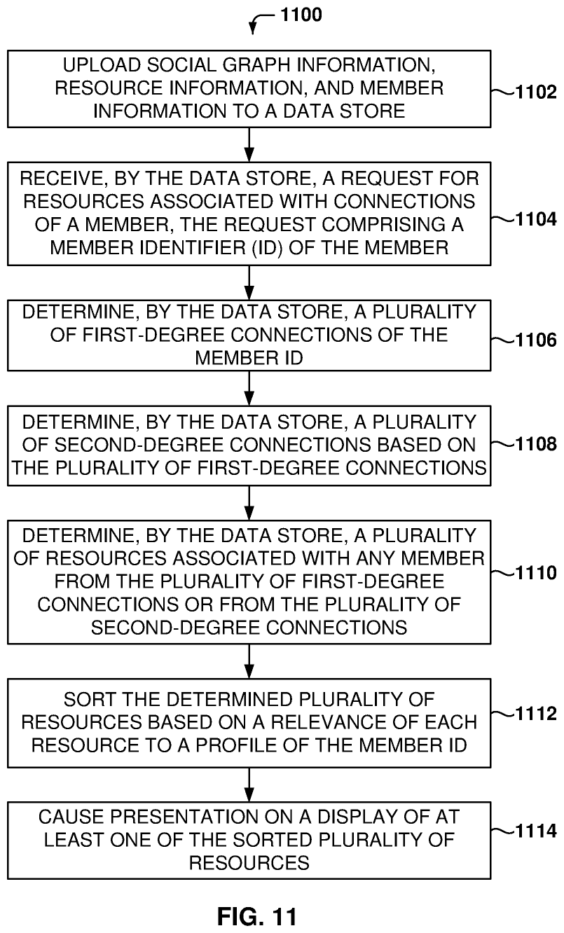

FIG. 11 is a flowchart of a method 1100 for finding job-posts shared or posted by the connections of a job-seeking member, according to some example embodiments. While the various operations in this flowchart are presented and described sequentially, one of ordinary skill will appreciate that some or all of the operations may be executed in a different order, be combined or omitted, or be executed in parallel.

Operation 1102 is for uploading social graph information, resource information, and member information to a data store. In some embodiments, the data store is an online data store that provides online results, and the data store is the online graph database.

From operation 1102, the method 1100 flows to operation 1104 for receiving, by the data store, a request for resources associated with connections of a member. The request comprises a member identifier (ID) of the member.

From operation 1104, the method 1100 flows to operation 1106 to determine, by the data store, a plurality of first-degree connections of the member ID.

From operation 1106, the method 1100 flows to operation 1108 to determine, by the data store, a plurality of second-degree connections based on the plurality of first-degree connections.

From operation 1108, the method 1100 flows to operation 1110 to determine, by the data store, a plurality of resources associated with any member from the plurality of first-degree connections or from the plurality of second-degree connections.

From operation 1110, the method 1100 flows to operation 1112 where the determined plurality of resources are sorted based on a relevance of each resource to a profile of the member ID.

From operation 1112, the method 1100 flows to operation 1114 for causing presentation on a display of at least one of the sorted plurality of resources.

In one example, the request further comprises a maximum number of resources to be returned, and determining the plurality of resources further comprises selecting the maximum number of resources based on a post date of each resource.

In one example, the request further comprises a maximum number of first-degree connections for selecting resources, and determining the plurality of first-degree connections further comprises selecting the maximum number of first-degree connections based on a connection strength between the member ID and first-degree connections of the member ID.

In one example, the connection strength is calculated by a machine-learning model trained with training data comprising member profile information and member activity information.

In one example, the request further comprises a maximum number of second-degree connections for selecting resources, and determining the plurality of second-degree connections further comprises selecting the maximum number of second-degree connections based on a connection strength between first-degree connections of the member ID and second-degree connections of the member ID.

In one example, the resource is a job post posted on an online service, and uploading social graph information comprises uploading a social graph, a connection strength for each connection in the social graph, job-post information comprising location, function, and title ID, and member information comprising location, function, and at least one title ID.

In one example, determining the plurality of first-degree connections further comprises excluding, from the plurality of first-degree connections, connections that are inactive.

In one example, the resource is a job post posted on an online service, and sorting the determined plurality of resources comprises, for each job post, calculating the relevance by a relevance machine-learning model trained with training data comprising job-post information, member profile information, and member activity information.

In one example, the resource is a job post posted on an online service, and the job posts associated with connections of the member include job posts that have been posted and job posts that have been shared by the connections of the member.

In one example, the resource is a job post posted on an online service, and determining the plurality of resources comprises filtering out job posts for a company where the member is currently employed.

Another general aspect is for a system that includes a memory comprising instructions and one or more computer processors. The instructions, when executed by the one or more computer processors, cause the one or more computer processors to perform operations comprising: uploading social graph information, resource information, and member information to a data store; receiving, by the data store, a request for resources associated with connections of a member, the request comprising a member identifier (ID) of the member; determining, by the data store, a plurality of first-degree connections of the member ID; determining, by the data store, a plurality of second-degree connections based on the plurality of first-degree connections; determining, by the data store, a plurality of resources associated with any member from the plurality of first-degree connections or from the plurality of second-degree connections; sorting the determined plurality of resources based on a relevance of each resource to a profile of the member ID; and causing presentation on a display of one or more of the sorted plurality of resources.

In yet another general aspect, a tangible machine-readable storage medium (e.g., a non-transitory storage medium) includes instructions that, when executed by a machine, cause the machine to perform operations comprising: uploading social graph information, resource information, and member information to a data store; receiving, by the data store, a request for resources associated with connections of a member, the request comprising a member identifier (ID) of the member; determining, by the data store, a plurality of first-degree connections of the member ID; determining, by the data store, a plurality of second-degree connections based on the plurality of first-degree connections; determining, by the data store, a plurality of resources associated with any member from the plurality of first-degree connections or from the plurality of second-degree connections; sorting the determined plurality of resources based on a relevance of each resource to a profile of the member ID; and causing presentation on a display of one or more of the sorted plurality of resources.

In view of the disclosure above, various examples are set forth below. It should be noted that one or more features of an example, taken in isolation or combination, should be considered within the disclosure of this application.

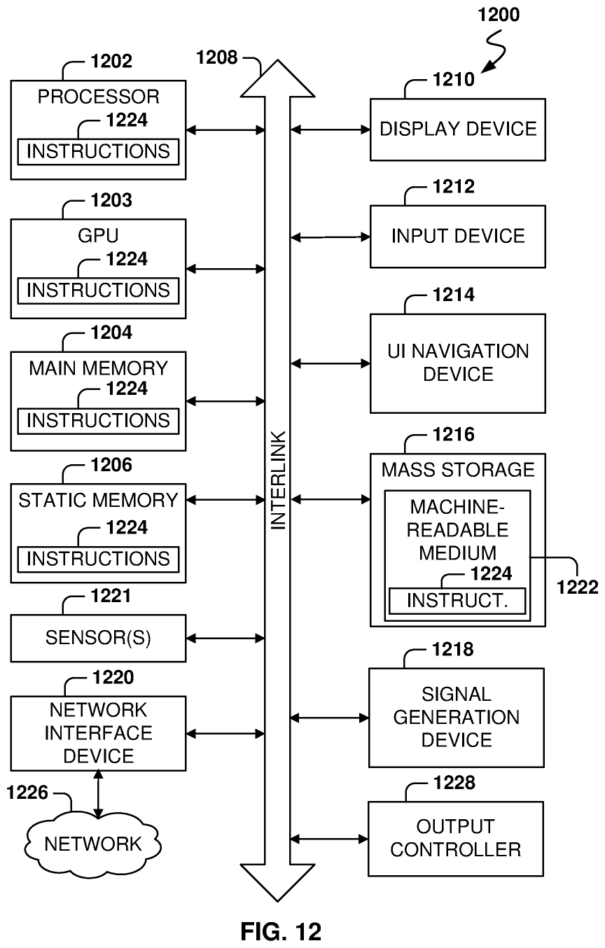

FIG. 12 is a block diagram illustrating an example of a machine 1200 upon or by which one or more example process embodiments described herein may be implemented or controlled. In alternative embodiments, the machine 1200 may operate as a standalone device or may be connected (e.g., networked) to other machines. In a networked deployment, the machine 1200 may operate in the capacity of a server machine, a client machine, or both in server-client network environments. In an example, the machine 1200 may act as a peer machine in a peer-to-peer (P2P) (or other distributed) network environment. Further, while only a single machine 1200 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1200 may include a hardware processor 1202 (e.g., a central processing unit (CPU), a hardware processor core, or any combination thereof), a graphics processing unit (GPU) 1203, a main memory 1204, and a static memory 1206, some or all of which may communicate with each other via an interlink (e.g., bus) 1208. The machine 1200 may further include a display device 1210, an alphanumeric input device 1212 (e.g., a keyboard), and a user interface (UI) navigation device 1214 (e.g., a mouse). In an example, the display device 1210, alphanumeric input device 1212, and UI navigation device 1214 may be a touch screen display. The machine 1200 may additionally include a mass storage device (e.g., drive unit) 1216, a signal generation device 1218 (e.g., a speaker), a network interface device 1220, and one or more sensors 1221, such as a Global Positioning System (GPS) sensor, compass, accelerometer, or another sensor. The machine 1200 may include an output controller 1228, such as a serial (e.g., universal serial bus (USB)), parallel, or other wired or wireless (e.g., infrared (IR), near field communication (NFC)) connection to communicate with or control one or more peripheral devices (e.g., a printer, card reader).

The mass storage device 1216 may include a machine-readable medium 1222 on which is stored one or more sets of data structures or instructions 1224 (e.g., software) embodying or utilized by any one or more of the techniques or functions described herein. The instructions 1224 may also reside, completely or at least partially, within the main memory 1204, within the static memory 1206, within the hardware processor 1202, or within the GPU 1203 during execution thereof by the machine 1200. In an example, one or any combination of the hardware processor 1202, the GPU 1203, the main memory 1204, the static memory 1206, or the mass storage device 1216 may constitute machine-readable media.

While the machine-readable medium 1222 is illustrated as a single medium, the term “machine-readable medium” may include a single medium, or multiple media, (e.g., a centralized or distributed database, and/or associated caches and servers) configured to store the one or more instructions 1224.

The term “machine-readable medium” may include any medium that is capable of storing, encoding, or carrying instructions 1224 for execution by the machine 1200 and that cause the machine 1200 to perform any one or more of the techniques of the present disclosure, or that is capable of storing, encoding, or carrying data structures used by or associated with such instructions 1224. Non-limiting machine-readable medium examples may include solid-state memories, and optical and magnetic media. In an example, a massed machine-readable medium comprises a machine-readable medium 1222 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1224 may further be transmitted or received over a communications network 1226 using a transmission medium via the network interface device 1220.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
uploading social graph information, resource information, and member information to a data store;
receiving, by the data store, a request for resources associated with connections of a member, the request comprising a member identifier (ID) of the member;
determining, by the data store, a plurality of first-degree connections of the member ID;
determining, by the data store, a plurality of second-degree connections based on the plurality of first-degree connections;
determining, by the data store, a plurality of resources associated with any member from the plurality of first-degree connections or from the plurality of second-degree connections;
sorting the determined plurality of resources based on a relevance of each resource to a profile of the member ID; and
causing presentation on a display of at least one of the sorted plurality of resources.

2. The method as recited in claim 1, wherein the request further comprises a maximum number of resources to be returned, wherein determining the plurality of resources further comprises:
selecting the maximum number of resources based on a post date of each resource.

3. The method as recited in claim 1, wherein the request further comprises a maximum number of first-degree connections for selecting resources, wherein determining the plurality of first-degree connections further comprises:
selecting the maximum number of first-degree connections based on a connection strength between the member ID and first-degree connections of the member ID.

4. The method as recited in claim 3, wherein the connection strength is calculated by a machine-learning model trained with training data comprising member profile information and member activity information.

5. The method as recited in claim 1, wherein the request further comprises a maximum number of second-degree connections for selecting resources, wherein determining the plurality of second-degree connections further comprises:
selecting the maximum number of second-degree connections based on a connection strength between the first-degree connections of the member ID and second-degree connections of the member ID.

6. The method as recited in claim 1, wherein the resource is a job post posted on an online service, wherein uploading social graph information comprises uploading:
a social graph;
a connection strength for each connection in the social graph;
job-post information comprising location, function, and title ID; and
member information comprising location, function, and at least one title ID.

7. The method as recited in claim 1, wherein determining the plurality of first-degree connections further comprises:
excluding, from the plurality of first-degree connections, connections that are inactive.

8. The method as recited in claim 1, wherein the resource is a job post posted on an online service, wherein sorting the determined plurality of resources comprises:
for each job post, calculating the relevance by a relevance machine-learning model trained with training data comprising job-post information, member profile information, and member activity information.

9. The method as recited in claim 1, wherein the resource is a job post posted on an online service, wherein the job posts associated with connections of the member include job posts that have been posted and job posts that have been shared by the connections of the member.

10. The method as recited in claim 1, wherein the resource is a job post posted on an online service, wherein determining the plurality of resources comprises:
filtering out job posts for a company where the member is currently employed.

11. A system comprising:
a memory comprising instructions; and
one or more computer processors, wherein the instructions, when executed by the one or more computer processors, cause the system to perform operations comprising:
uploading social graph information, resource information, and member information to a data store;
receiving, by the data store, a request for resources associated with connections of a member, the request comprising a member identifier (ID) of the member;
determining, by the data store, a plurality of first-degree connections of the member ID;
determining, by the data store, a plurality of second-degree connections based on the plurality of first-degree connections;
determining, by the data store, a plurality of resources associated with sponsored by any member from the plurality of first-degree connections or from the plurality of second-degree connections;
sorting the determined plurality of resources based on a relevance of each resource to a profile of the member ID; and
causing presentation on a display of at least one of the sorted plurality of resources.

12. The system as recited in claim 11, wherein the request further comprises a maximum number of resources to be returned, wherein determining the plurality of resources further comprises:
selecting the maximum number of resources based on a post date of each resource.

13. The system as recited in claim 11, wherein the request further comprises a maximum number of first-degree connections for selecting resources, wherein determining the plurality of first-degree connections further comprises:
selecting the maximum number of first-degree connections based on a connection strength between the member ID and first-degree connections of the member ID.

14. The system as recited in claim 13, wherein the connection strength is calculated by a machine-learning model trained with training data comprising member profile information and member activity information.

15. The system as recited in claim 11, wherein the request further comprises a maximum number of second-degree connections for selecting resources, wherein determining the plurality of second-degree connections further comprises:
selecting the maximum number of second-degree connections based on a connection strength between the member ID and second-degree connections of the member ID.

16. A tangible machine-readable storage medium including instructions that, when executed by a machine, cause the machine to perform operations comprising:
uploading social graph information, resource information, and member information to a data store;
receiving, by the data store, a request for resources associated with connections of a member, the request comprising a member identifier (ID) of the member;
determining, by the data store, a plurality of first-degree connections of the member ID;
determining, by the data store, a plurality of second-degree connections based on the plurality of first-degree connections;
determining, by the data store, a plurality of resources associated with any member from the plurality of first-degree connections or from the plurality of second-degree connections;
sorting the determined plurality of resources based on a relevance of each resource to a profile of the member ID; and
causing presentation on a display of at least one of the sorted plurality of resources.

17. The tangible machine-readable storage medium as recited in claim 16, wherein the request further comprises a maximum number of resources to be returned, wherein determining the plurality of resources further comprises:
selecting the maximum number of resources based on a post date of each resource.

18. The tangible machine-readable storage medium as recited in claim 16, wherein the request further comprises a maximum number of first-degree connections for selecting resources, wherein determining the plurality of first-degree connections further comprises:
selecting the maximum number of first-degree connections based on a connection strength between the member ID and first-degree connections of the member ID.

19. The tangible machine-readable storage medium as recited in claim 18, wherein the connection strength is calculated by a machine-learning model trained with training data comprising member profile information and member activity information.

20. The tangible machine-readable storage medium as recited in claim 16, wherein the request further comprises a maximum number of second-degree connections for selecting resources, wherein determining the plurality of second-degree connections further comprises:
selecting the maximum number of second-degree connections based on a connection strength between the member ID and second-degree connections of the member ID.
